(19) United States
(12) Patent Application Publication
(10) Pub. No.: US 2026/0163300 A1
(43) Pub. Date: Jun. 11, 2026

(54) CABLE FIXING CLAMP

(71) Applicant: Inventec Appliances Corp., New Taipei City (TW)

(72) Inventors: Ping Chia CHENG, New Taipei City (TW); Kuei Yang CHEN, New Taipei City (TW)

(21) Appl. No.: 19/207,346

(22) Filed: May 13, 2025

(30) Foreign Application Priority Data
Dec. 11, 2024 (TW) 113213628

(51) Int. Cl. H01R 13/627; H01R 13/639

(52) U.S. Cl. CPC H01R 13/6275; H01R 13/639

(57) ABSTRACT

A cable fixing clamp includes two body portions, at least one cable fastener, and a connecting member. The two body portions are configured to be connected in a closed state or an opened state, the two body portions forming a cable clamping groove in the closed state and opening the cable clamping groove by locally bending away from each other in the opened state. The at least one cable fastener is disposed in the cable clamping groove. The connecting member is coupled to one side of the two body portions and has a through hole communicated with the cable clamping groove.

### CROSS - REFERENCE TO RELATED APPLICATION

This application claims priority to Taiwan Application Serial Number 113213628, filed December 11, 2024, which is herein incorporated by reference in its entirety.

### BACKGROUND

### Field of Invention

The present disclosure relates to a cable fixing clamp. More specifically, the present disclosure relates to a cable fixing clamp for use on the exterior of vehicle-mounted equipment.

### Description of Related Art

Among existing cable fixing methods, common methods include screw locking (e.g., VGA cable), fixing to equipment using a special clamp structure (e.g., Ethernet cables), and stabilizing a cable by means of a cable clamp fixed to the equipment. However, removal may not be possible with the screw locking method due to corrosion of the screws, and since the cables are firmly fixed to the equipment, if someone accidentally kicks the cables, this may cause the person to trip and fall, or may lead to a fall of the equipment and damage to the cables.

Therefore, there is a need for a cable fixing clamp that can solve the above problems.

### SUMMARY

The invention provides a cable fixing clamp, which includes two body portions, at least one cable fastener, and a connecting member. The two body portions are configured to be connected in a closed state or an opened state, the two body portions forming a cable clamping groove in the closed state and opening the cable clamping groove by locally bending away from each other in the opened state. The at least one cable fastener is disposed in the cable clamping groove. The connecting member is coupled to one end of the two body portions and has a through hole communicated with the cable clamping groove.

In some embodiments of the present disclosure, each of the two body portions comprises an engaging structure located at an end thereof adjacent to the connecting member. The engaging structures of the two body portions are connected to each other.

In some embodiments of the present disclosure, the engaging structure comprises an engaging slot and an engaging bump. The engaging bump of one body portion is engaged the engaging slot of the other body portion.

In some embodiments of the present disclosure, each of the two body portions further comprises a buckling structure located at an end thereof away from the connecting member. The buckling structures of the two body portion are configured to buckle with each other.

In some embodiments of the present disclosure, the buckling structure comprises a buckling piece and a buckling seat. The buckling piece of one body portion is buckled with the buckling seat of another of the other body portion upon buckling.

In some embodiments of the present disclosure, the cable fastener is a sheet-like structure.

In some embodiments of the present disclosure, each of the two body portions further comprises a folding groove located at an end thereof adjacent to the connecting member. The two body portions are bent locally away from each other along the folding grooves.

In some embodiments of the present disclosure, each body portion comprises an upper semi-circular ring, a lower semi-circular ring, and two connecting arms. The upper semi-circular ring is located at an end of said each of the body portions away from the connecting member. The upper semi-circular ring has a first opening in a semicircular shape. The lower semi-circular ring is located at the end of said each of the two body portions adjacent to the connecting member. The lower semi-circular ring has a second opening in a semicircular shape. One connecting arm is coupling one end of the upper semi-circular ring to one end of the lower semi-circular ring, and the other connecting arm is coupling opposite ends thereof. The first openings of the two body portions collectively form a first circular hole. The second openings of the two body portions collectively form a second circular hole. The first circular hole and the second circular hole together define the cable clamping groove.

In some embodiments of the present disclosure, in the opened state, the first circular hole is opened by moving the upper semi-circular rings of the two body portions away from each other to open the cable clamping groove.

In some embodiments of the present disclosure, the upper semi-circular ring further comprises an inner wall in the first opening. The cable fastener is located at the inner wall.

In some embodiments of the present disclosure, each of the two body portions further comprises a folding groove located at the connecting arm. The two body portions are bent locally away from each other along the folding grooves.

In some embodiments of the present disclosure, the folding groove is located at an end of the connecting arm adjacent to the lower semi-circular ring.

In some embodiments of the present disclosure, the folding grooves of the two body portions are faced to bending directions of the two body portions.

In some embodiments of the present disclosure, the two body portions have identical structures.

In some embodiments of the present disclosure, the connecting member is a solid-phase adhesive.

In summary, the cable fixing clamp of the present disclosure can be easily assembled by means of two body portions having substantially the same structure, and through the design of the cable fasteners and the buckling structures, the cable fixing clamp can be bent to open and close for simple fastening of the cable. In addition, the cable fixing clamp can be easily mounted on the equipment by means of the adhesive connection, and remains securely fixed and is not easily loosened in a vibration environment.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a cable fixing clamp according to some embodiments of the present disclosure;

FIG. 2 is an exploded perspective view of the cable fixing clamp according to some embodiments of the present disclosure;

FIG. 3 is another perspective view of the cable fixing clamp according to some embodiments of the present disclosure;

FIG. 4 is a perspective view showing a clamp positioned within the cable fixing clamp;

FIG. 5 is a cross-sectional view of the cable fixing clamp mounting the cable on equipment according to some embodiments of the present disclosure;

FIG. 6 is a perspective view of the cable fixing clamp disposed on the equipment according to some embodiments of the present disclosure; and

FIG. 7 is a perspective view of the cable fixing clamp fixing the cable on the equipment according to one embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

It should be understood that when an element or layer is referred to as being “connected to” or “coupled to” another, it can be directly connected or coupled, or additional intervening components may be present.

To clearly illustrate the positional relationships and alignments between the various components, coordinate axes are indicated in the diagrams, namely the first axis x, the second axis y, and the third axis z.

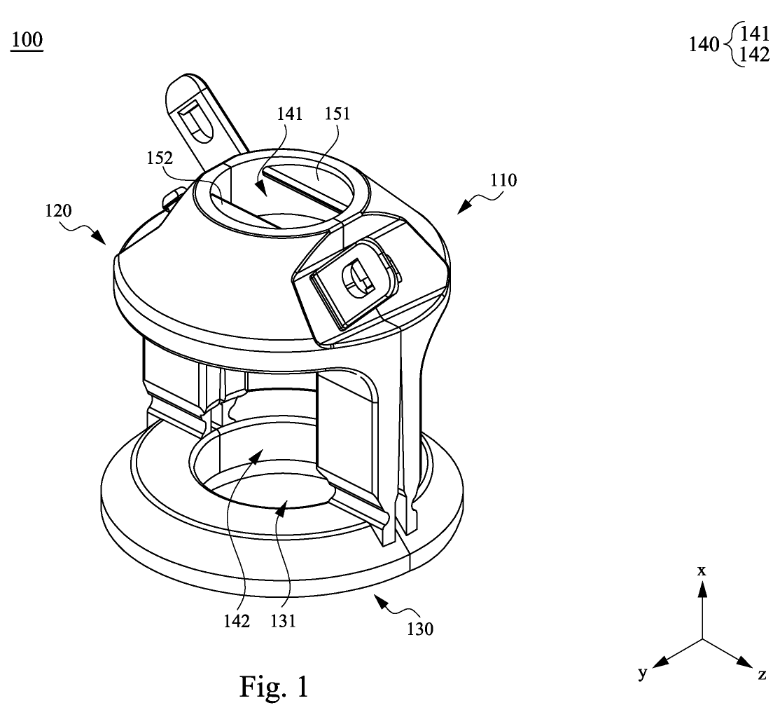

Referring to FIG. 1, a perspective view is shown of a cable fixing clamp 100 according to some embodiments of the present disclosure. In some embodiments, the cable fixing clamp 100 includes a body portion 110, a body portion 120, and a connecting member 130. The connecting member 130 is coupled to one end of the body portions 110 and 120 to hold the body portions 110 and 120 against each other. The body portions 110 and 120 form a cable clamping groove 140. The connecting member 130 includes a through hole 131 in communication with the cable clamping groove 140.

In some embodiments, the body of the cable fixing clamp 100 is formed by the body portions 110 and 120, which are structurally identical. Due to their identical structure, the two body portions may be easily assembled without regard to orientation. In some embodiments, the cable fixing clamp 100 is mounted to equipment via the connecting member 130, which affixes the cable to the exterior of the equipment and eliminates the need for internal chassis modifications. For example, the connecting member 130 has an adhesive property and is configured to bond the body portion 110 and the body portion 120 to the housing of the equipment.

In some embodiments, the cable fixing clamp 100 includes at least one cable fastener disposed in the cable clamping groove 140, configured to secure a cable and limit its position. In some embodiments, the cable fixing clamp 100 includes cable fasteners 151 and 152.

In some embodiments, the body portions 110 and 120 are connected in a closed state. The two body portions are secured on one side via the connecting member 130. The opposite side forms the cable clamping groove 140 in the closed state.

In some embodiments, a material of the body portions 110 and 120 can be a plastic having elasticity and high toughness, e.g., polypropylene (PP), but the present disclosure is not limited thereto. In some embodiments, the connecting member 130 is a solid-phase adhesive or an adhesive pad.

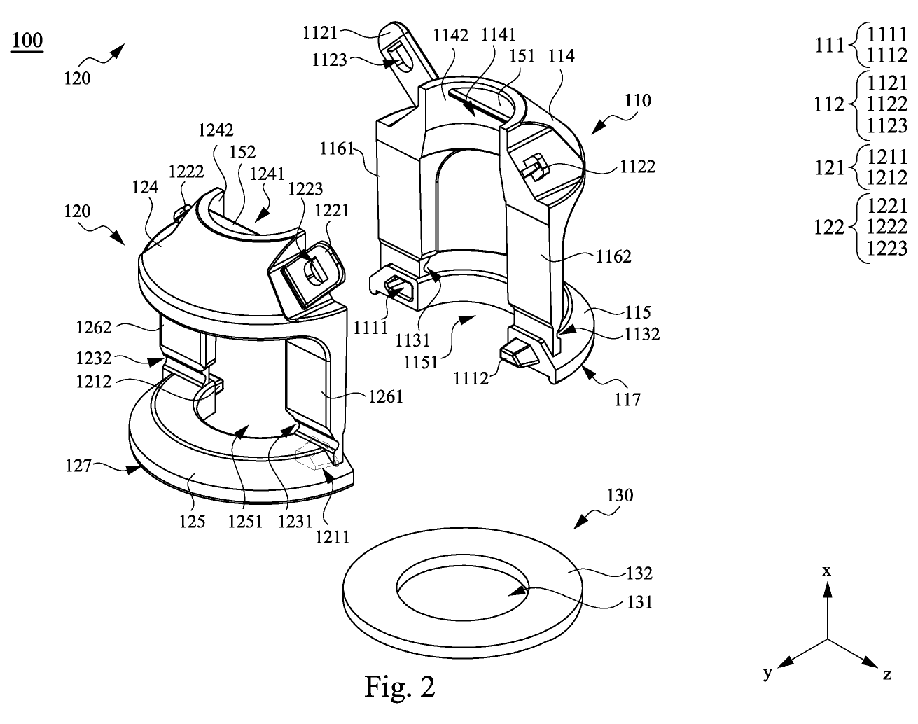

Referring to FIG. 2, an exploded perspective view of the cable fixing clamp 100 is shown in accordance with certain embodiments of the present disclosure.

In some embodiments, the body portion 110 further includes an engaging structure 111 and the body portion 120 further includes an engaging structure 121. The engaging structures 111 and 121 are located at respective ends of the body portions 110 and 120, adjacent to the connecting member 130. The engaging structures 111 and 121 are connected to each other to enhance the structure stability of the cable fixing clamp 100.

In some embodiments, the engaging structure 111 includes an engaging slot 1111 and an engaging bump 1112, and the engaging structure 121 includes an engaging slot 1211 and an engaging bump 1212. The engaging bump 1112 is engaged with the engaging slot 1211, and the engaging bump 1212 is engaged with the engaging slot 1111, to connect the body portion 110 and the body portion 120.

In some embodiments, the body portion 110 further includes a buckling structure 112, and the body portion 120 further includes a buckling structure 122. The buckling structures 112 and 122 are located at ends of the body portions 110, 120, opposite the connecting member 130.

In some embodiments, the buckling structure 112 includes a buckling piece 1121 and a buckling seat 1122, and the buckling structure 122 includes a buckling piece 1221 and a buckling seat 1222. The buckling pieces 1121 and 1221 include holes 1123 and 1223.

In some embodiments, the body portion 110 includes folding grooves 1131 and 1132, while the body portion 120 includes folding grooves 1231 and 1232. The folding grooves 1131, 1132, 1231, and 1232 are located at ends of the body portions 110 and 120 adjacent to the connecting member 130.

In some embodiments, the body portion 110 further includes an upper semi-circular ring 114, a lower semi-circular ring 115, a connecting arm 1161 and a connecting arm 1162. The upper semi-circular ring 114 is located at one end of the body portion 110 away from the connecting member 130. The upper semi-circular ring 114 has a first opening 1141 in a semicircular shape and an inner wall 1142 located in the first opening 1141. The lower semi-circular ring 115 is located at another end of the body portion 110 adjacent to the connecting member 130 and has a second opening 1151 in a semicircular shape. The connecting arms 1161 and 1162 extend between respective ends of the upper and lower semi-circular rings 114 and 115.

In some embodiments, the folding grooves 1131 and 1132 of the body portion 110 are located at the connecting arms 1161 and 1162, respectively. More particularly, the folding grooves 1131 and 1132 are located at one end of the connecting arms 1161 and 1162, respectively, adjacent to the lower semi-circular ring 115.

In some embodiments, the body portion 120 further includes an upper semi-circular ring 124, a lower semi-circular ring 125, a connecting arm 1261 and a connecting arm 1262. The upper semi-circular ring 124 is located at one end of the body portion 120 away from the connecting member 130. The upper semi-circular ring 124 has a first opening 1241 in a semicircular shape and an inner wall 1242 located in the first opening 1241. The lower semi-circular ring 125 is located at another end of the body portion 120 adjacent to the connecting member 130 and has a second opening 1251 in a semicircular shape. The connecting arms 1261 and 1262 extend between respective ends of the upper and lower semi-circular rings 124 and 125.

In some embodiments, the folding grooves 1231 and 1232 of the body portion 120 are located at the connecting arms 1261 and 1262, respectively. More particularly, the folding grooves 1231 and 1232 are located at one end of the connecting arms 1261 and 1262, respectively, adjacent to the lower semi-circular ring 125.

In some embodiments, the body portions 110 and 120 further include bottom sides 117 and 127, respectively, connected to the connecting member 130. The connecting member 130 is connected to the bottom side 117 and the bottom side 127 by a surface 132.

More particularly, for the body portion 110, engaging slot 1111 is located at one end of the lower semi-circular ring 115 connecting to the connecting arm 1161. The engaging bump 1112 is located at another end of the lower semi-circular ring 115 connecting to the connecting arm 1162. In other words, the engaging structure 111 is located at the bottom of the body portion 110 near the bottom side 117, and at the ends of the lower semi-circular ring 115 there are the engaging slot 1111 and the engaging bump 1112, respectively. The buckling piece 1121 is located at one end of the upper semi-circular ring 114 connecting to the connecting arm 1161. The buckling seat 1122 is located at another end of the upper semi-circular ring 114 connecting to the connecting arm 1162. In other words, the buckling structure 112 is located at the top of the body portion 110 away from the bottom side 117, and at the ends of the upper semi-circular ring 114 there are the buckling piece 1121 and the buckling seat 1122. As the structure of the body portion 120 is the same as that of the body portion 110, reference may be made to the description above for the detailed structure of the body portion 120.

In some embodiments, the first openings 1141 and 1241 collectively form a first circular hole 141. The second openings 1151 and 1251 collectively form a second circular hole 142. The first circular hole 141 and the second circular hole 142 form a space for the cable to pass through to form the cable clamping groove 140 (see to FIG. 1).

In some embodiments, the cable fastener 151 is located at the inner wall 1142 of the upper semi-circular ring 114 of the body portion 110. The cable fastener 152 is located at the inner wall 1242 of the upper semi-circular ring 124 of the body portion 120. In some embodiments, each of the cable fasteners 151 and 152 is a sheet-like structure. More particularly, for the body portion 110, the cable fastener 151 extends from the inner wall 1142 in a direction away from the inner wall 1142, but does not extend to fill the first opening 1141, but extends only to a certain extent.

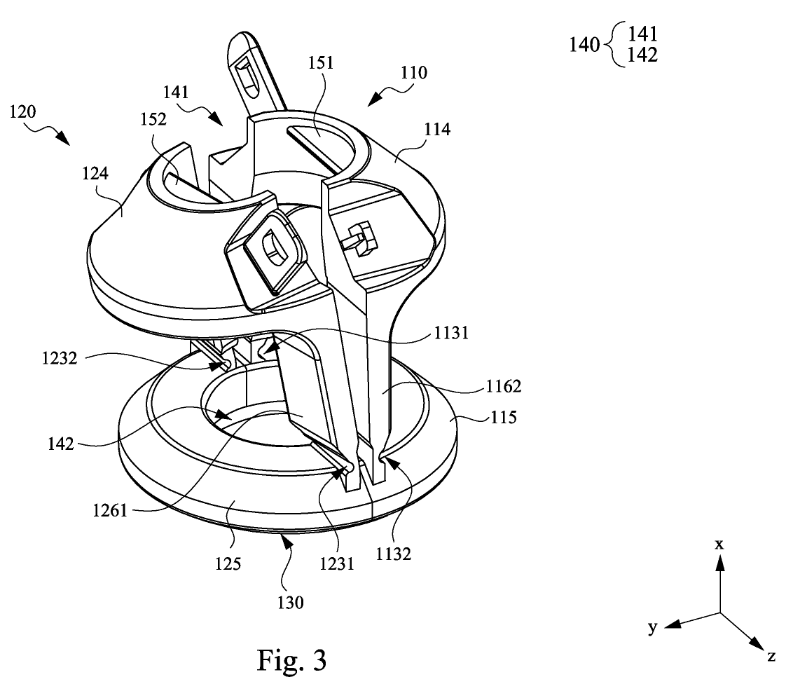

FIG. 3 is another perspective view of the cable fixing clamp 100 according to some embodiments of the present disclosure.

In FIG. 3, the body portions 110 and 120 are connected in an opened state. The two body portions 110, 120 are fixed by connecting one end of the two body portions 110, 120 through the connecting member 130, and the other end of the two body portions 110, 120 away from the connecting member 130 is partially bent away from each other to place the cable clamping groove 140 in the opened state.

In some embodiments, the body portion 110 and the body portion 120 are bent locally away from each other along the folding grooves 1131, 1132, 1231, and 1232 to present the opened state. In some embodiments, the connecting arm 1162 is bent along the folding groove 1132 so that the upper semi-circular ring 114 is moved away from the body portion 120. The connecting arm 1261 is bent along the folding groove 1232 so that the upper semi-circular ring 115 is moved away from the body portion 110. As a result, the upper semi-circular ring 114 and the upper semi-circular ring 115 move away from each other to open the first circular hole 141 and then open the cable clamping groove 140.

In some embodiments, the folding grooves 1131, 1132, 1231, and 1232 are faced to bending directions of the body portion 110 and the body portion 120. More particularly, the folding grooves 1131 and 1132 are faced to bending directions of the body portion 110, and the folding grooves 1231 and 1232 are faced to bending directions of the body portion 120.

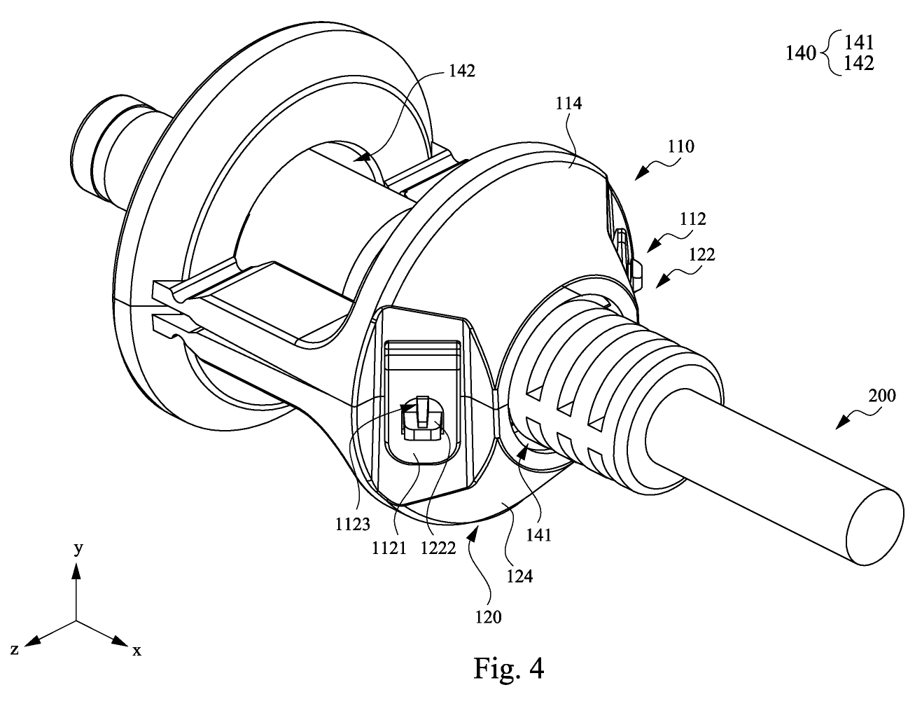

Reference is made to FIG. 4, which is a perspective view of the cable fixing clamp and a cable according to some embodiments of the present disclosure. The cable 200 is installed in the cable fixing clamp 100 through the cable clamping groove 140, specifically through the first circular hole 141, the second circular hole 142, and the through hole 131.

In FIG. 4, the buckling structures 112 and 122 of the cable fixing clamp 100 buckle together to form a locked state (see FIG. 2). The buckling piece 1121 buckles with the buckling seat 1222 through the hole 1123 (see FIG. 2). The buckling piece 1221 buckles with the buckling seat 1122 through the hole 1223 (see FIG. 2). The upper semi-circular rings 114 and 115 are fixedly connected to each other through the buckling of the buckling structure 112 of the body portion 110 and the buckling structure 122 of the body portion 120, so as to fasten the cable 200.

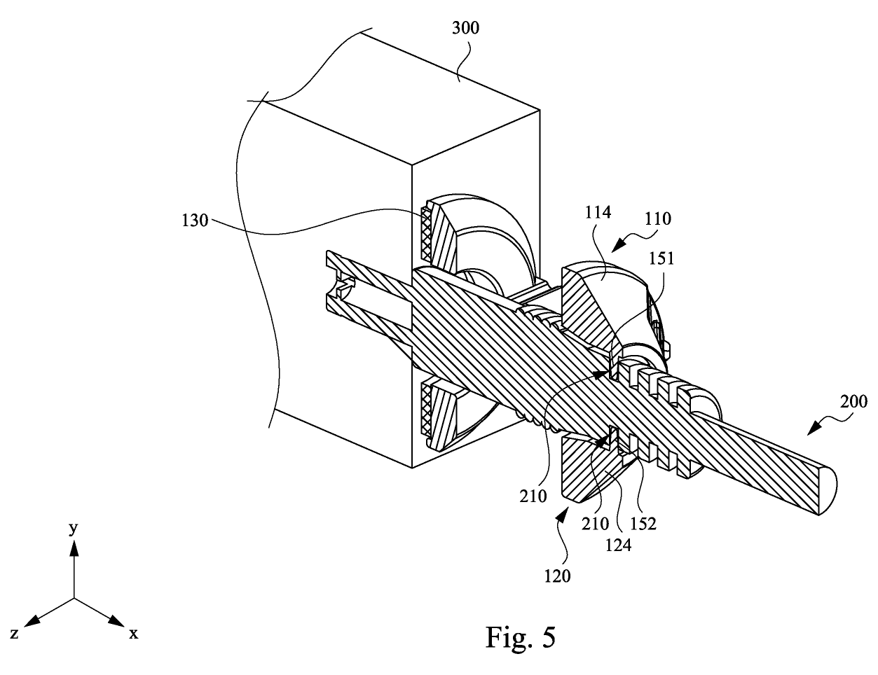

Reference is made to FIG. 5, which is a cross-sectional view of the cable fixing clamp mounting the cable on equipment according to some embodiments of the present disclosure. The cable 200 has a cable slot 210 on the outer layer thereof. When mounted on the cable fixing clamp 100, the cable fasteners 151 and 152 engage the cable slot 210 to fix the cable 200 so that the cable 200 cannot be moved axially along the cable clamping groove 140.

In some embodiments, the equipment 300 can be any equipment that needs to secure the cable 200, e.g., electronic devices such as personal computers, servers, and in-vehicle computers.

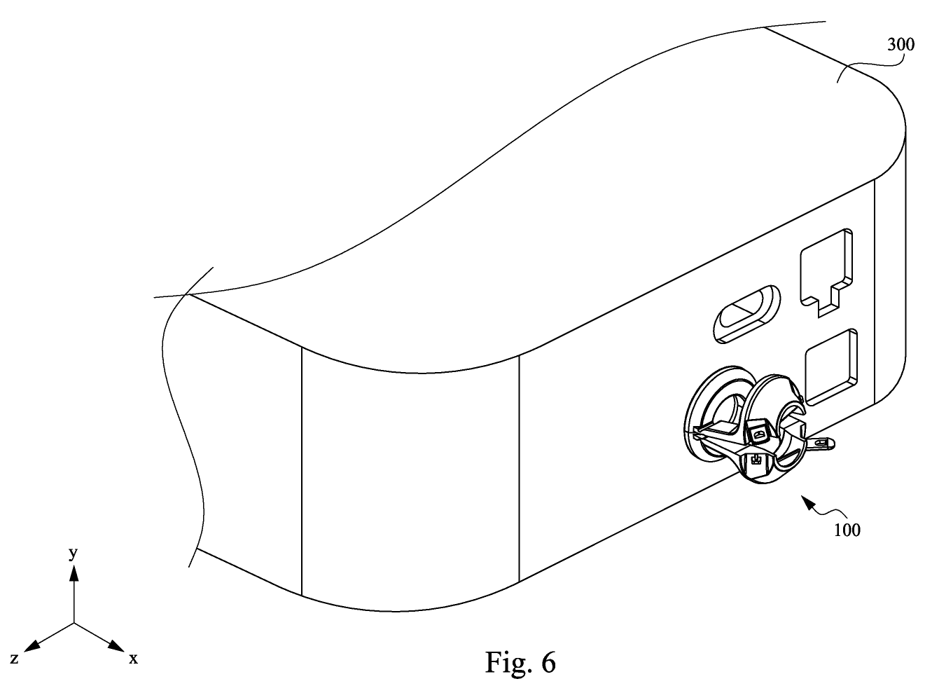

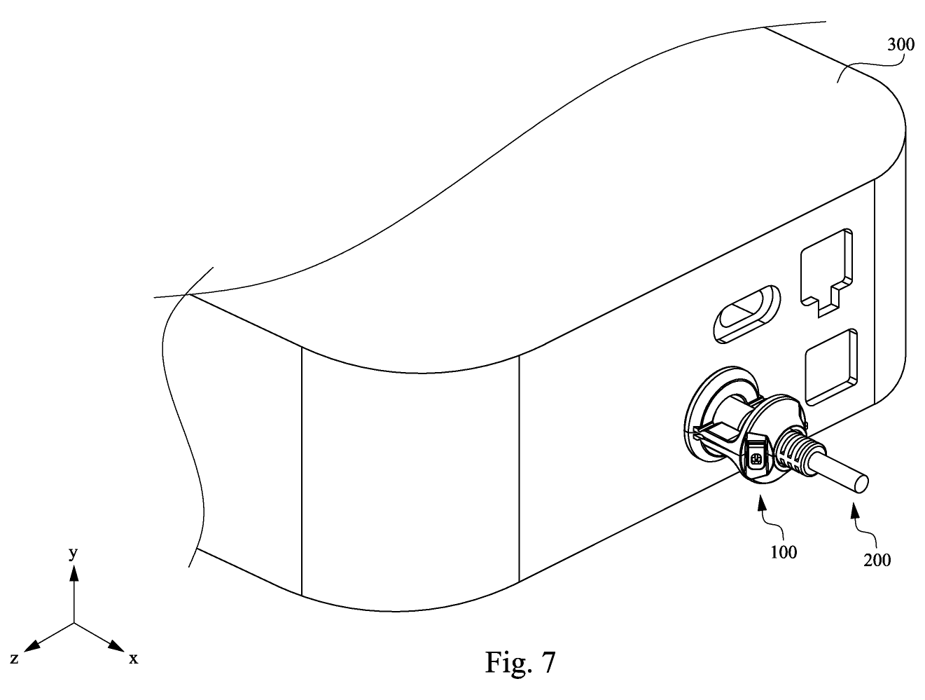

Reference is made to FIGS. 6 and 7, which illustrate the cable fixing clamp disposed on the equipment and the cable securing the cable to the equipment, respectively. Further reference is made to FIGS. 1 to 4 for the following description.

In some embodiments, securing the cable 200 using the cable fixing clamp 100 involves: (a) assembling body portions 110 and 120 with connecting member 130 to form the clamp and adhering it to a predetermined position on the equipment 300 (see FIG. 6); (b) bending body portions 110 and 120 to open the cable clamping groove 140; (c) inserting cable 200 into the cable clamping groove 140 to mount it on the equipment 300; (d),engaging buckling structures 112 and 122 of the cable fixing clamp 100 in the locked state (see FIG. 7).

In summary, the cable fixing clamp disclosed herein can be easily assembled using two body portions of substantially identical structure, and through the design of the cable fasteners and the buckling structures, the cable fixing clamp can be bent to open and close for simple fastening of the cable. In addition, the cable fixing clamp can be easily mounted on the equipment by means of the adhesive connection, and remains securely fixed and is not easily loosened in a vibration environment.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A cable fixing clamp comprising:
two body portions configured to be connected in a closed state or an opened state, forming a cable clamping groove in the closed state and opening the cable clamping groove by locally bending away from each other in the opened state;
at least one cable fastener disposed in the cable clamping groove; and
a connecting member coupled to one end of the two body portions and having a through hole communicated with the cable clamping groove.

2. The cable fixing clamp of claim 1, wherein each body portion comprises an engaging structure located at an end thereof adjacent to the connecting member, the engaging structures of the two body portions being connected to each other.

3. The cable fixing clamp of claim 2, wherein the engaging structure comprises an engaging slot and an engaging bump, the engaging bump of one body portion engaging the engaging slot of the other body portion.

4. The cable fixing clamp of claim 1, wherein each body portions comprises a buckling structure at the end away from the connecting member, the buckling structures of the two body portions being configured to buckle with each other.

5. The cable fixing clamp of claim 4, wherein the buckling structure comprises a buckling piece and a buckling seat, the buckling piece of one body portion engaging the buckling seat of the other body portion upon buckling.

6. The cable fixing clamp of claim 1, wherein the cable fastener comprises a sheet-like structure.

7. The cable fixing clamp of claim 1, wherein each of the two body portions comprises a folding groove located at an end thereof adjacent to the connecting member, wherein the two body portions are bent locally away from each other along the folding grooves.

8. The cable fixing clamp of claim 1, wherein each body portion comprises:
an upper semi-circular ring at the end away from the connecting member, the upper semi-circular ring having a semicircular first opening;
a lower semi-circular ring at the end adjacent to the connecting member, the lower semi-circular ring having a semicircular second opening; and
two connecting arms, one connecting arm coupling one end of the upper semi-circular ring to one end of the lower semi-circular ring, and the other connecting arm coupling the opposite ends thereof;
wherein the first openings of the two body portions collectively form a first circular hole, the second openings of the two body portions collectively form a second circular hole, and the first and the second circular holes together define the cable clamping groove.

9. The cable fixing clamp of claim 8, wherein in the opened state, the first circular hole is opened by moving the upper semi-circular rings of the two body portions away from each other to open the cable clamping groove.

10. The cable fixing clamp of claim 8, wherein the upper semi-circular ring further comprises an inner wall in the first opening, the cable fastener being located at the inner wall.

11. The cable fixing clamp of claim 8, wherein each of the two body portions further comprises a folding groove located at the connecting arm, wherein the two body portions are bent locally away from each other along the folding grooves.

12. The cable fixing clamp of claim 11, wherein the folding groove is located at an end of the connecting arm adjacent to the lower semi-circular ring.

13. The cable fixing clamp of claim 11, wherein the folding grooves are faced to bending directions of the two body portions.

14. The cable fixing clamp of claim 1, wherein the two body portions have identical structures.

15. The cable fixing clamp of claim 1, wherein the connecting member is a solid-phase adhesive.
